(19) United States
(12) Patent Application Publication
(10) Pub. No.: US 2011/0198389 A1
(43) Pub. Date: Aug. 18, 2011

(54) Friction Welding Apparatus

(75) Inventors: Daniel Gerhardus Hattingh, Port Elizabeth (ZA); Ian Norman Wedderburn, Port Elizabeth (ZA); Philip Doubell, Pretoria (ZA)

(73) Assignee: NELSON MANDELA METROPOLITAN UNIVERSITY, Port Elizabeth (ZA)

(21) Appl. No.: 12/995,014

(22) PCT Filed: May 29, 2009
(86) PCT No.: PCT/AZ2009/000004

§ 371 Date: Feb. 23, 2011

(30) Foreign Application Priority Data
May 28, 2008 (ZA) 2008/04630

(51) Int. Cl. B23K 20/12; B23K 31/02

(52) U.S. Cl. 228/114; 228/2.1

(57) ABSTRACT

This invention relates to a friction welding apparatus, and more particularly, but not exclusively, to a modular friction welding apparatus suitable for in-situ reparation of blind holes in pipes. The friction welding apparatus includes a frame assembly, a spindle assembly for holding a friction welding consumable; and a drive assembly for driving a spindle of the spindle assembly. The spindle assembly and the drive assembly are releasably securable to the frame assembly so as to form a modular friction welding apparatus, and the frame assembly is furthermore removable securable to an object to be welded.

### BACKGROUND OF THE INVENTION

THIS invention relates to a friction welding apparatus, and more particularly, but not exclusively, to a modular friction welding apparatus suitable for in-situ reparation of blind holes in pipes. The invention also extends to a method of removing a core sample from a material to be tested, for example a pipe, which method includes the step of repairing the blind hole from which the core sample has been removed using the friction welding apparatus.

Friction welding is a material processing and joining technology which essentially comprises a solid-phase welding technique in which frictional heat is used to join materials. One particular form of frictional welding is the so-called Friction Hydra Pillar Processing (FHPP) technique. FHPP entails the rotation of a consumable rod co-axially in a circular or tapered hole. Whilst rotating, a compressive force is also applied to the consumable rod in order continuously to generate plasticized layers, so as to obtain a metallurgical bond of high integrity. A similar process is the Friction Tapered Stud Welding (FTSW) technique, in which a tapered stud is welded into an aperture in a substrate. It is important to differentiate FHPP ant FTSW from friction welding processes such as friction stir welding, as in FHPP and FTSW the rotated component is welded into an aperture to be repaired, whereas the rotating tool in a stir welding process is only used to create heat, and is not a welding consumable.

FHPP and FTSW are not new techniques or processes as such, but the use thereof has heretofore been limited to factory and workshop application due to the size and complexity of existing FHPP and FTSW devices. In many applications, such as when plugging blind holes formed in pipes after core samples have been removed, the FHPP or FTSW techniques would be most suitable, but to date this has not been practically feasible due to the size and complexity of existing devices.

It is accordingly an object of the invention to provide a friction welding apparatus that will, at least partially, alleviate the above disadvantages, and which will be a useful alternative to known devices used to perform FHPP or FTSW.

It is in particular an object of the invention to provide a FHPP and/or FTSW apparatus that can be used to perform the FHPP and/or FTSW techniques in-situ.

### SUMMARY OF THE INVENTION

According to the invention there is provided a friction welding apparatus including:
a frame assembly,
a spindle assembly for holding a friction welding consumable for use in the FHPP or FTSW process; and
a drive assembly for rotating a spindle of the spindle assembly in order for the consumable to be rotatable co-axially inside a hole in an object to be repaired;
the spindle assembly and the drive assembly being releasably securable to the frame assembly so as to form a modular friction welding apparatus; and
the frame assembly being removably securable to the object to be repaired.

The frame assembly preferably includes securing means for securing the frame assembly, and thus the friction welding apparatus, to the object to be welded.

Typically, the frame assembly includes a primary frame section, with at least two leg sections extending from the primary frame section to form the securing means. The leg sections are preferably of an arcuate configuration in order at least partially to straddle an object to be welded.

The leg sections are secured to the object by way of chains and chain clamps that extends about a periphery of the object.

The object to be welded may be a pipe.

The frame assembly may also include a secondary frame section having a cavity for receiving the drive assembly. The frame assembly may still further include a tertiary section having a cavity for receiving the spindle assembly.

The drive assembly and spindle assembly is releasably securable to the frame assembly by way of securing means. Preferably the securing means are in the form of toggle clamps.

In a preferred embodiment the drive assembly comprises driving means that is electrically operated. The driving means may be in the form of a Servo motor.

The spindle assembly includes a rotatable spindle for transmitting rotation to the friction welding consumable secured thereto.

There is also provided for the spindle to be linearly displaceable along a longitudinal axis of the spindle, in order for the welding consumable to be displaceable into the aperture in the Object to be welded.

A force imparting means is provided for imparting a compressive force onto the spindle assembly, and thus the consumable rod, when it is displaced into the aperture to be welded.

The force imparting means is in the form of at least one piston and cylinder arrangement, and preferably includes at least two hydraulic piston and cylinder arrangements.

According to a further aspect of the invention there is provided a friction welding apparatus including:
a frame assembly for releasably carrying a spindle assembly and a drive assembly.
the frame assembly including securing means for securing the frame assembly, and thus the friction welding apparatus, to an object to be welded.

Typically, the securing means are in the form of leg sections extending from the frame assembly in order for the frame assembly to at least partially straddle the object to be welded.

The friction welding apparatus preferably also includes a spindle assembly for holding a consumable rod, and a drive assembly for driving a spindle of the spindle assembly, wherein the spindle assembly and the drive assembly are releasably securable to the frame assembly so as to form a modular friction welding apparatus.

According to a further aspect of the invention there is provided a method of taking a core sample from a steel object, the method including the steps of:
cutting an annular hole in the object,
forming en undercut at the bottom of the hole;
removing a cylindrical sample formed by the cutting process; and
seating a blind hole remaining after the sample has bean removed using a friction welding process.

Preferably the friction welding process is performed in-situ using the friction welding apparatus as described above.

The cylindrical sample may be removed by imparting a torque on the sample, in order for the sample to shear from the object at the undercut end.

### BRIEF DESCRIPTION OF THE DRAWINGS

A preferred embodiment of the invention is described by way of a non-limiting example, and with reference to the accompanying figures in which:

FIG. 1 is a perspective view of the friction welding apparatus in accordance with the invention, wherein the apparatus is mounted on and secured to a pipe to be welded;

FIG. 2 is a side view of the friction welding apparatus of FIG. 1;

FIG. 3 an end view of the friction welding apparatus of FIG. 1;

FIG. 4 is a plan view of the friction welding apparatus of FIG. 1;

FIG. 5 is a perspective view of the friction welding apparatus in accordance with the invention, showing the drive assembly and the spindle assembly in an exploded view to demonstrate the modular configuration thereof;

FIG. 6 is a perspective view of the frame assembly of the friction welding apparatus;

FIG. 7 is a perspective view of the drive assembly of the friction welding apparatus; and

FIG. 8 is a perspective view of the spindle assembly of the friction welding apparatus.

### DETAILED DESCRIPTION OF THE INVENTION

Referring to the drawings, in which like numerals indicate like features, a non-limiting example of the friction welding apparatus in accordance with the invention is indicated by reference numeral 10. The friction welding apparatus 10 comprises a frame assembly 20, a drive assembly 30 and a spindle assembly 40.

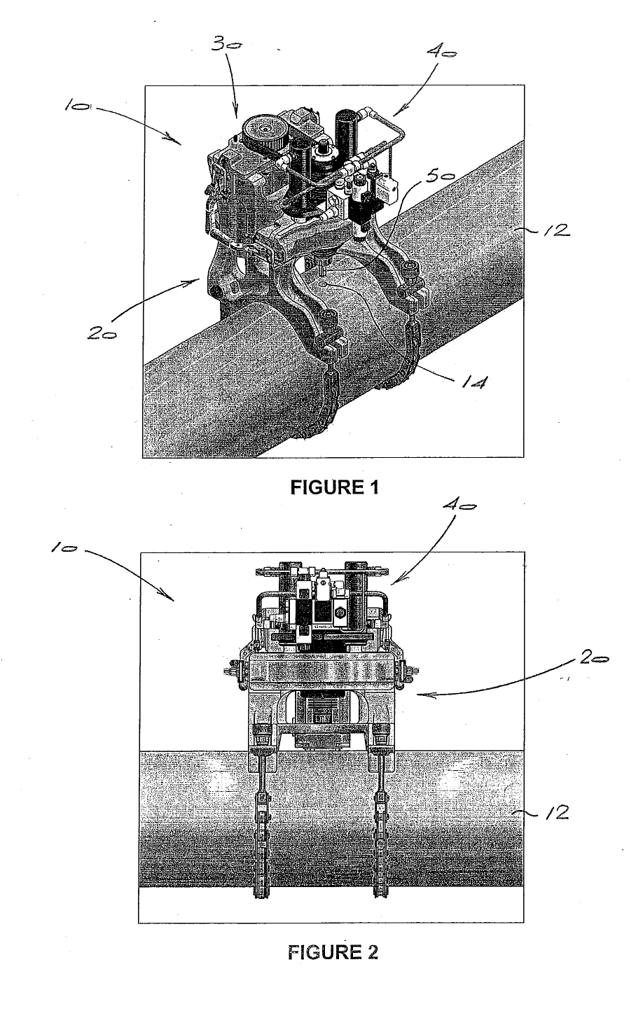

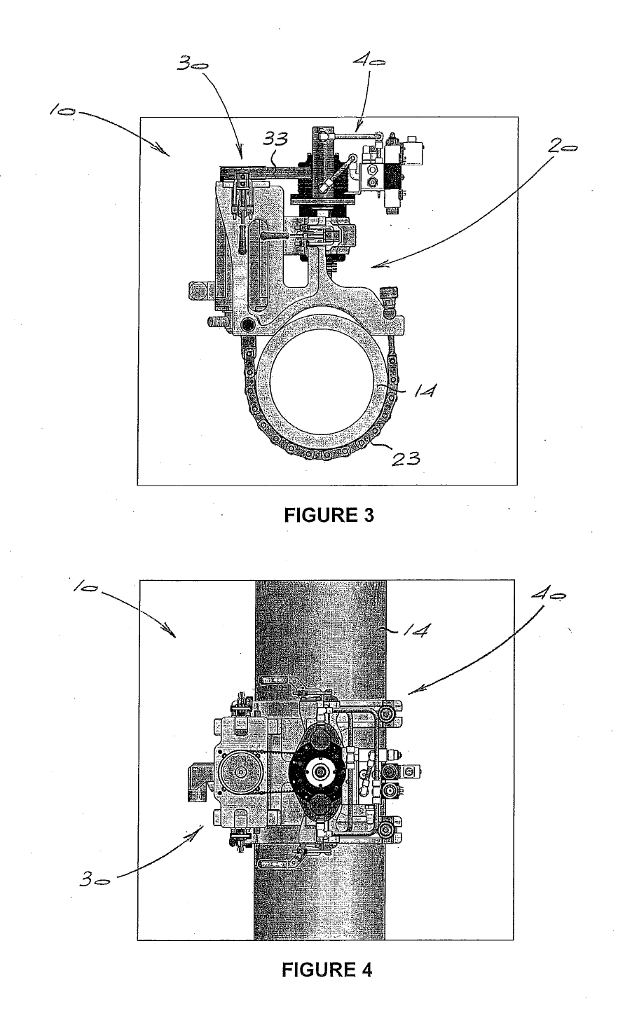

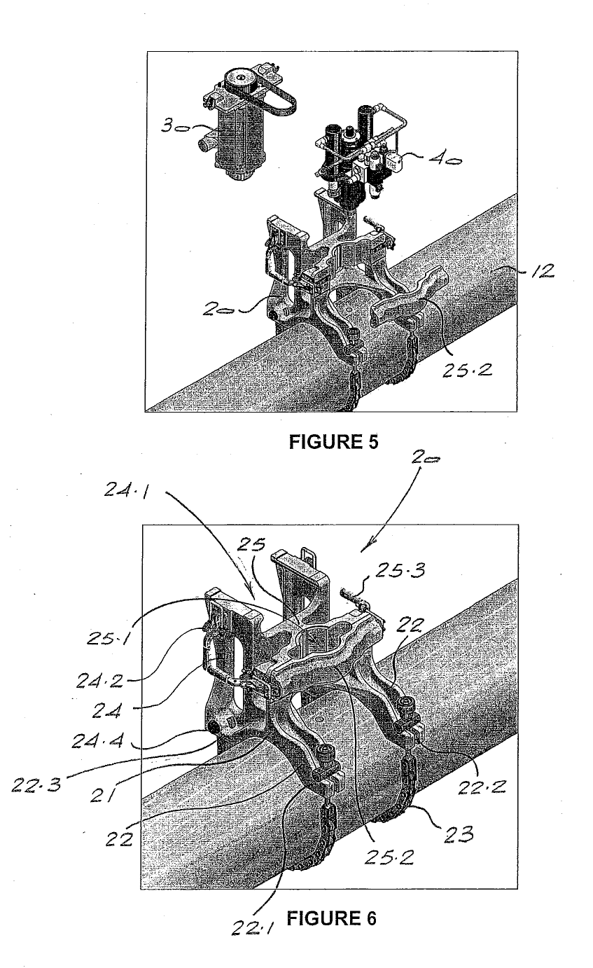

In FIG. 1 the friction welding apparatus 10 is shown in use secured to a pipe 12 in which an aperture 14 (in the form of a blind hole) is to be repaired. The application shown is for exemplification, and it is foreseeable that the friction welding apparatus 10 can be secured to various different objects to perform various welding functions.

The frame assembly 20 of the apparatus 10 (as can best be seen in FIG. 6) includes a primary frame section 21, a secondary frame section 24 and a tertiary frame section 25, which are all integrally formed or alternatively securable to one another to provide a rigid frame assembly 20. The primary frame section 21 is adapted to rest on and straddle the pipe 12 to be welded, and proper abutment of the pipe 12 is achieved by providing leg sections 22 that extend from the primary frame section 21. The leg sections 22 are at least partially arcuate in order to follow the curved profile of the pipe 12. First ends 22.1 and second ends 22.2 of the leg section 22 are secured to one another by way of a securing means in the form of a securing chain 23, thus trapping the pipe 12 between the primary frame Section 21 and the chain 23. The ends of the leg sections terminate in slots 22.2 and securing formations 22.4 to enable the chain clamps 23 to be secured to the frame.

The secondary frame section 24 includes a cavity 24.1 which is configured and dimensioned to receive the drive assembly 30 therein. The drive assembly 30 is secured to the secondary frame section 24 (and thus the frame assembly 20) by way of a plurality of securing means in the form of toggle clamps 24.2.

The tertiary frame section 25 also includes a cavity 25.1 for receiving the spindle assembly 40. One wall of the cavity 25.1 is integrally formed with the frame, and a second inverse wall is defined by a yoke 25.2 which in used forces the spindle assembly into abutment with the frame. The yoke 25.2 is releasably securable to the tertiary frame section by, way of a plurality of securing means in the form of toggle clamps 25.3.

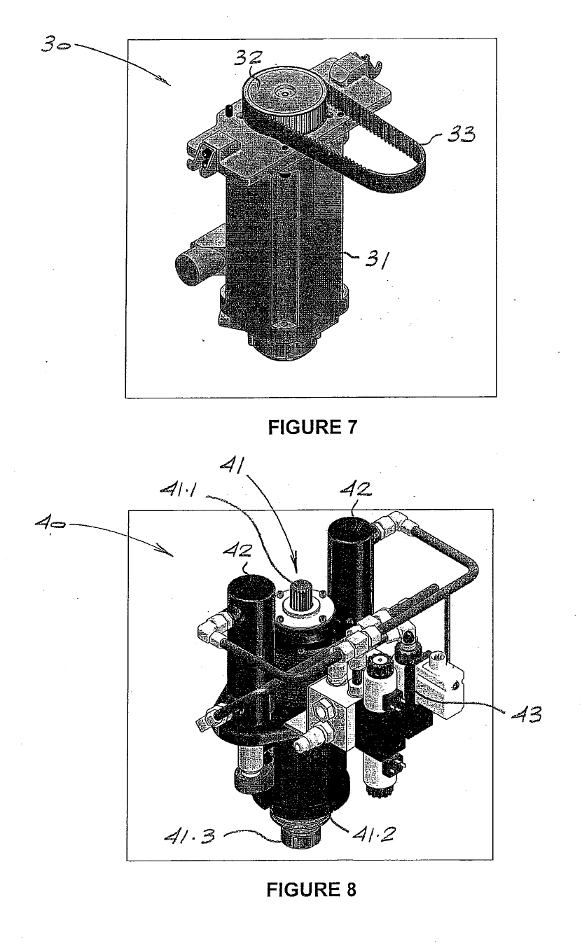

Referring now to FIG. 7, the drive assembly 30 includes a driving means 31, in this example in the form of a Servo motor, with a sprocket 32 being secured to an end of a drive shaft of the driving means. A transmission belt 33 is also provided for engaging the spindle assembly 40, so as to be able to transmit rotation of the drive assembly 30 to the spindle assembly 40.

The spindle assembly 40, best seen in FIG. 8, comprises a spindle arrangement 41, hydraulic cylinders 42 and a hydraulic control system 43. The spindle arrangement 41 includes a spindle housing 41.2, with a spindle drive end 41.1 and a rotatable head 41.3 extending from opposite ends of the spindle housing 42.2. The drive end 41.1 is engaged by the transmission belt 33 which causes the (not shown in FIG. 7) extends from the rotating head 41.3, and engages the aperture 14 to be repaired.

Hydraulic cylinders 42 are provided to impart a compressive force on the spindle, in order for a required vertical load to be exerted on the consumable rod 50, which in use extends form the rotating head. The compressive force is required to obtain the correct operating conditions for forming a suitable weld. It will be appreciated that the rotational speed and the compressive force are variables that should be controlled relative to one another, and for this purpose a hydraulic control system 43 is furthermore provided in order to control the operation and force imparted by the hydraulic cylinders 42. The spindle is configured for the consumable to be displaceable in a direction perpendicular to the pipe on which the apparatus is installed. More particularly, the consumable can be displaced into a hole to be repaired when the cylinders are actuated.

In use the frame assembly 20 is secured to the object (in this case pipe 12) to be welded. Once secured, the drive assembly 30 and the spindle assembly 40 are mounted onto the frame assembly 20. The transmission belt 33 is subsequently connected between the spindle and drive assemblies, and the friction welding apparatus 10 is ready for use.

The friction welding apparatus 10 is fully automated during a welding cycle. Particular welding parameters are programmed via an external control unit by an operator, and once the weld cycle has started the apparatus completes the plug weld without any further operator input.

The inventors foresee that the new friction welding apparatus will be useful and will solve problems associated with existing devices in that the apparatus is modular, thus resulting in easy transport, in-situ installation and removal. The apparatus is furthermore specifically adapted to be locatable on curved surfaces, although it will be appreciated that this does not necessarily need to be the case.

It is foreseen that the friction welding will find particular application during the process of taking in-situ core samples from objects that need to be assessed, such as for example large diameter and wall-thickness steam pipes. It is envisaged that the method of taking such a core sample will entail the steps of:
cutting an annular hole in the object using a suitable cutting apparatus,
forming an undercut at the bottom of the hole, the undercut being directed radially inwardly towards the centre of the cylindrical sample pillar formed by the initial cut;
removing the cylindrical sample formed by the cutting process above by applying a torque on the sample, in order for the sample to shear from the object at the undercut end; and
sealing a blind hole remaining after the sample has been removed using a friction welding process.

In particular, it is foreseen that the friction welding apparatus described above will be particularly suitable for use in the above method, due to its modular nature, and due to the fact that it can be installed in-situ on the pipe from which the sample is to be taken, thus negating the need from taking the pipe out of service. This will obliviously result in a major decrease in downtime, whilst still providing a safe method of taking core samples.

It will be appreciated that the above is only one embodiment of the invention and that there may be many variations without departing from the spirit and/or scope of the invention.

1-14. (canceled)

15. A friction welding apparatus comprising:
a frame assembly,
a spindle assembly for holding a friction welding consumable for use in a FHPP or FTSW process; and
a drive assembly for rotating a spindle of the spindle assembly in order for the consumable to be rotatable co-axially inside a hole in an object to be repaired;
with the spindle assembly and the drive assembly being releasably securable to the frame assembly so as to form a modular friction welding apparatus; and
with the frame assembly being removably securable to the object to be repaired.

16. The friction welding apparatus of claim 15, wherein the frame assembly includes securing means for securing the frame assembly, and thus the friction welding apparatus, to the object to be welded, in order for the spindle assembly to be locatable above a blind hole in the object to be welded.

17. The friction welding apparatus of claim 15, wherein the frame assembly includes a primary frame section, with at least two leg sections extending from the primary frame section in order to, in use, straddle the object to be welded.

18. The friction welding apparatus of claim 17, wherein the object to be welded is a pipe.

19. The friction welding apparatus of claim 17, wherein the frame assembly includes a secondary frame section having a cavity for receiving the drive assembly, and a tertiary frame section having a cavity for receiving the spindle assembly.

20. The friction welding apparatus of claim 15, wherein the drive assembly and spindle assembly are releasably securable to the frame assembly by way of securing means.

21. The friction welding apparatus of claim 15, wherein the spindle assembly includes a rotatable spindle that is rotated by the driving means in order to transmit rotation to the friction welding consumable secured thereto.

22. The friction welding apparatus of claim 21, wherein the spindle is linearly displaceable along a longitudinal axis of the spindle, in order for the welding consumable to be displaceable into the aperture in the object to be welded.

23. The friction welding apparatus of claim 22, wherein a force imparting means is provided for imparting a compressive force onto the spindle assembly, and thus the consumable rod, when it is displaced into the aperture to be welded.

24. The friction welding apparatus of claim 23, wherein the force imparting means is in the form of at least one piston and cylinder arrangement.

25. A method of taking a core sample from a steel object, the method comprising the steps of:
(a) cutting an annular hole in the object;
(b) forming an undercut at the bottom of the hole;
(c) removing a cylindrical sample formed by the cutting process; and
(d) sealing a blind hole remaining after the sample has been removed using a friction welding process.

26. The method of claim 25, wherein the friction welding process is performed in situ using the friction welding apparatus as claim in claim 15.

27. The method of claim 25, wherein the undercut is directed radially inwardly towards the centre of a cylindrical sample pillar formed by the initial annular cut.

28. The method of claim 25, wherein the cylindrical sample is removed by imparting a torque on the sample, in order for the sample to shear from the object at the undercut end.

29. The method of claim 27, wherein the cylindrical sample is removed by imparting a torque on the sample, in order for the sample to shear from the object at the undercut end.
